(19) United States
(12) Patent Application Publication
(10) Pub. No.: US 2025/0105755 A1
(43) Pub. Date: Mar. 27, 2025

(54) METHOD FOR CONTROLLING RESONANT CIRCUIT AND RESONANT CIRCUIT

(71) Applicant: Delta Electronics (Shanghai) CO., LTD., Shanghai (CN)

(72) Inventors: Yuesen GUO, Shanghai (CN); Lu WANG, Shanghai (CN); Kai DONG, Shanghai (CN); Chang XU, Shanghai (CN)

(73) Assignee: Delta Electronics (Shanghai) CO., LTD., Shanghai (CN)

(21) Appl. No.: 18/789,761

(22) Filed: Jul. 31, 2024

(30) Foreign Application Priority Data
Sep. 21, 2023 (CN) 2023112275381

(51) Int. Cl. H02M 3/335

(52) U.S. Cl. CPC H02M 3/33592

(57) ABSTRACT

The present disclosure provides a method for controlling a resonant circuit and a resonant circuit. The resonant circuit to which the method is applicable includes: a primary switching circuit, configured to receive an input voltage; a resonant branch, including a capacitor and an inductor connected in series; a transformer, including a primary winding and a secondary winding, and the resonant branch is connected between the primary switching circuit and the primary winding; and a secondary switching circuit, connected to the secondary winding and configured to provide an output voltage to a load, and the secondary switching circuit includes a synchronous rectifier switch, and the synchronous rectifier switch includes a body diode; the method includes: adjusting, in different working periods, a conduction time of the body diode to cause a switching frequency of the resonant circuit to change.

### CROSS REFERENCE

The present application claims priority to Chinese Patent Application No. 2023112275381, filed on Sep. 21, 2023, the entire contents of which are incorporated herein by reference.

### TECHNICAL FIELD

The present disclosure relates to the field of power supply technologies, and in particular to a method for controlling a resonant circuit and a resonant circuit.

### BACKGROUND

Harmonic components associated with a switching noise in an LLC resonant converter are quite large. In order to comply with EMI standards, effective suppression solutions should be taken. In the related arts, frequency jitter technologies are used to distribute energy within a certain frequency band around a fundamental frequency and harmonic frequencies. In this way, under the premise of a total energy remaining unchanged, an energy at each point within the frequency band will be less than an initial energy. Therefore, a value detected by a test device is less than an initial value, which is beneficial for reaching a limit specified by the standards and meeting EMI test requirements.

It should be noted that the information disclosed in the Background section above is only for enhancing the understanding of the background of the present disclosure, and thus may include information that does not constitute prior art known to those of ordinary skill in the art.

### SUMMARY

According to a first aspect of the present disclosure, there is provided a method for controlling a resonant circuit, wherein the resonant circuit includes:
a primary switching circuit, configured to receive an input voltage;
a resonant branch, including a capacitor and an inductor connected in series;
a transformer, including a primary winding and a secondary winding, wherein the resonant branch is connected between the primary switching circuit and the primary winding; and
a secondary switching circuit, connected to the secondary winding and configured to provide an output voltage to a load, wherein the secondary switching circuit includes a synchronous rectifier switch, and the synchronous rectifier switch includes a body diode;
the method includes:
adjusting, in different working periods, a conduction time of the body diode to cause a switching frequency of the resonant circuit to change.

According to a second aspect of the present disclosure, there is further provided a resonant circuit, including:
a primary switching circuit, configured to receive an input voltage;
a resonant branch, including a capacitor and an inductor connected in series;
a transformer, including a primary winding and a secondary winding, wherein the resonant branch is connected between the primary switching circuit and the primary winding;
a secondary switching circuit, connected to the secondary winding and configured to provide an output voltage to a load, wherein the secondary switching circuit includes a synchronous rectifier switch, and the synchronous rectifier switch includes a body diode; and
a controller, configured to adjust, in different working periods, a conduction time of the body diode to cause a switching frequency of the resonant circuit to change.

According to a third aspect of the present disclosure, there is further provided an electronic device, including: a processor; and a memory configured to store executable instructions of the processor; wherein the processor is configured to execute the method for controlling the resonant circuit in the first aspect as described above by executing the executable instructions.

It should be noted that the above general description and the following detailed description are merely exemplary and explanatory and should not be construed as limiting of the disclosure.

### BRIEF DESCRIPTION OF THE DRAWINGS

The drawings herein are incorporated in and constitute a part of the specification, illustrate embodiments consistent with the present disclosure, and together with the description serve to explain principles of the present disclosure. Apparently, the drawings in the following description are only some embodiments of the present disclosure. For those of ordinary skill in the art, other drawings may be obtained based on these drawings without paying any creative effort.

FIG. 1 shows a schematic structural diagram of a resonant circuit according to an embodiment of the present disclosure;

FIG. 2 shows a schematic diagram of a method for controlling a resonant circuit according to an embodiment of the present disclosure;

FIG. 3 shows a block diagram of a control logic for a synchronous rectifier switch Sₛ₂ in the related arts;

FIG. 4 shows a block diagram of a control logic for a synchronous rectifier switch Sₛ₂ by applying a control method provided by an embodiment of the present disclosure;

FIG. 5 shows a schematic diagram of primary and secondary driving signals corresponding to FIG. 3 according to an embodiment of the present disclosure;

FIG. 6 shows a schematic diagram of primary and secondary driving signals corresponding to FIG. 4 according to an embodiment of the present disclosure; and

FIG. 7 shows a simplified schematic structural diagram of a resonant circuit according to an embodiment of the present disclosure.

### DETAILED DESCRIPTION

Example embodiments will now be described more fully with reference to the accompanying drawings. However, the example embodiments can be implemented in a variety of forms and should not be construed as being limited to examples set forth herein; rather, these embodiments are provided so that the present disclosure will be more complete and comprehensive so as to convey the idea of the example embodiments to those skilled in this art. The described features, structures or characteristics may be combined in any suitable manner in one or more embodiments.

In addition, the drawings are merely schematic representations of the present disclosure and are not necessarily drawn to scale. The same reference numerals in the drawings denote the same or similar parts, and the repeated description thereof will be omitted. Some of the block diagrams shown in the figures are functional entities and do not necessarily correspond to physically or logically separate entities. These functional entities may be implemented in software, or implemented in one or more hardware modules or integrated circuits, or implemented in different networks and/or processor devices and/or microcontroller devices.

As described above, harmonic components associated with a switching noise in an LLC resonant converter are quite large. In order to comply with EMI standards, effective suppression solutions should be taken. In the related arts, frequency jitter technologies are used to distribute energy within a certain frequency band around a fundamental frequency and harmonic frequencies. In this way, under the premise of a total energy remaining unchanged, an energy at each point within the frequency band will be less than an initial energy. Therefore, a value detected by a test device is less than an initial value, which is beneficial for reaching a limit specified by the standards and meeting EMI test requirements.

An LLC resonant circuit is typically used as a post-stage circuit of a two-stage circuit. When an input voltage of a pre-stage circuit of the two-stage circuit is a direct current (DC) voltage, or the input voltage of the pre-stage circuit of the two-stage circuit is an alternating current (AC) voltage and the two-stage circuit is under light load conditions, a switching frequency of the resonant circuit hardly changes, resulting in the inability to reduce the noise energy through the frequency jitter, which in turn leads to a large switching noise and cannot meet the EMI test requirements.

SPecific implementations of embodiments of the present disclosure will be described in detail below with reference to the accompanying drawings.

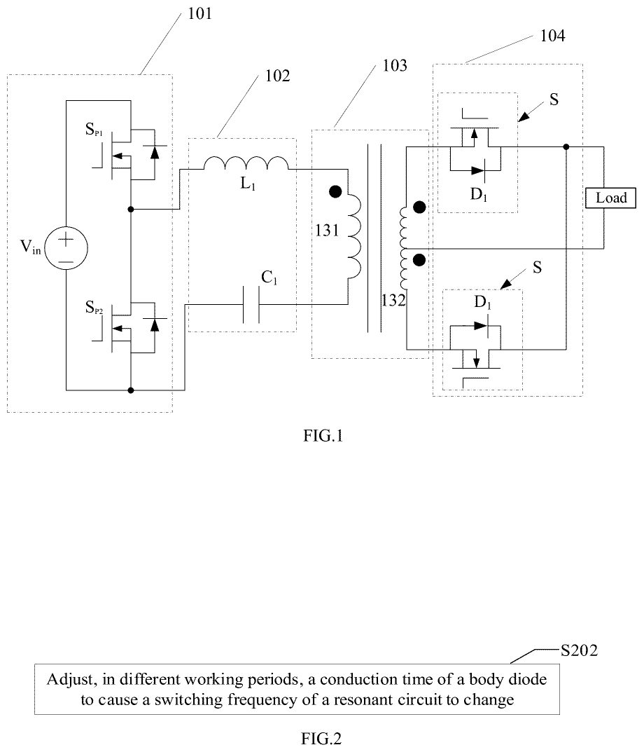

A resonant circuit shown in FIG. 1 includes:
a primary switching circuit 101, configured to receive an input voltage Vin; as shown, the primary switching circuit 101 generally includes two switches S_{P1} and S_{P2}, which may be Metal-Oxide-Semiconductor Field-Effect Transistors (MOSFETs) or may be Insulated Gate Bipolar Transistors (IGBTs);
a resonant branch 102, including a capacitor C₁ and an inductor L₁ connected in series;
a transformer 103, including a primary winding 131 and a secondary winding 132, and the resonant branch 102 is connected between the primary switching circuit 101 and the primary winding 131; and
a secondary switching circuit 104, connected to the secondary winding 132 and configured to provide an output voltage to a load;
the secondary switching circuit 104 includes a synchronous rectifier switch S, and the synchronous rectifier switch S includes a body diode D₁.

It should be noted that in some embodiments of the present disclosure, the secondary switching circuit 104 includes two synchronous rectifier switches S, and each synchronous rectifier switch S includes a body diode D₁. The secondary winding 132 has two end points and a center tap. The two rectifier switches S rectify a voltage provided by the secondary winding 132 and then power the load.

An expression of a voltage gain G of the resonant circuit shown in FIG. 1 is shown in formula (1):

$$G = \frac{n {V}_{o} + {V}^{′}}{{V}_{i n}} = \frac{1}{\sqrt{{( 1 + λ - \frac{λ}{{f}_{n}^{2}} )}^{2} + {Q}^{2} {( {f}_{n} - \frac{1}{{f}_{n}} )}^{2}}} \qquad ( 1 )$$

where Vₒ represents an output voltage;
n represents a transformation ratio of the transformer 103;
V′ represents a voltage drop of the synchronous rectifier switch S;
Vᵢₙ represents the input voltage;
Q represents a quality factor;

$$λ = \frac{{L}_{r}}{{L}_{n}} ,$$

Lᵣ represents an inductance of the inductor L₁; Lₙ represents an inductance of an excitation inductor;

$${f}_{n} = \frac{{f}_{s w}}{{f}_{r}} ,$$

f_{sw} represents a switching frequency of the synchronous rectifier switch S; fᵣ represents a resonant frequency of the resonant circuit, and

$${f}_{r} = \frac{1}{2 π \sqrt{{L}_{r} {C}_{r}}} ,$$

Cᵣ represents a capacitance value of the capacitor C₁.

λ, n and fᵣ are fixed, and in a case where the output remains unchanged (that is, Vₒ remains unchanged), when there is no change in V′, whether the switching frequency of the resonant circuit changes only depends on whether the input voltage Vᵢₙ changes. When the pre-stage circuit whose output connects to the input of the resonant circuit has the DC input or has the AC input with the load of the resonant circuit being light, Vᵢₙ hardly changes, resulting in the switching frequency of the resonant circuit hardly changing. However, reducing the noise energy through the frequency jitter technology requires the switching frequency of the resonant circuit to change, which means that in these two cases, the frequency jitter technology cannot be used to reduce the noise energy.

Embodiments of the present disclosure provide a method for controlling a resonant circuit. As shown in FIG. 2, the method includes a step S202.

In the S202, a conduction time of a body diode is adjusted in different working periods to cause a switching frequency of the resonant circuit to change.

It should be noted that when the synchronous rectifier switch S is turned on and has been working in a synchronous rectification mode, a periodic average value V₁ of a conduction voltage drop of the synchronous rectifier switch S is as shown in formula (2):

$${V}_{1} = \frac{2}{{T}_{s}} {\int }^{\frac{2}{{T}_{s}}} ( {R}_{dson} \times {i}_{sec} ) \times ndt \qquad ( 2 )$$

where Tₛ represents a switching period of the synchronous rectifier switch S;
R_{dson} represents an on resistance of the synchronous rectifier switch S;
i_{sec} represents a current flowing through the synchronous rectifier switch S; and
n represents the transformation ratio of the transformer 103;
when the synchronous rectifier switch S is turned on, it works in the synchronous rectification mode for a period of time, and the body diode D₁ is turned on for a period of time, in this case, the periodic average value V₂ of the conduction voltage drop of the synchronous rectifier switch S is shown in formula (3):

$${V}_{2} = \frac{2}{{T}_{s}} [ {\int }_{0}^{{T}_{s 1}} ( {R}_{dson} \times {i}_{sec} ) \times ndt + {\int }_{{T}_{s 1}}^{{T}_{s 2}} {V}_{D 1} \times ndt ] \qquad ( 3 )$$

where 0˜ Tₛ₁ represents a period when the synchronous rectifier switch works in the synchronous rectification mode; Tₛ₁˜ Tₛ₂ represents a period when the body diode D₁ is turned on; and V_{D1} represents a forward conduction voltage of the body diode D₁.

As can be seen from formula (3), when the conduction time of the body diode D₁ changes, the voltage V₂ will change. Substituting V₂ in the formula (3) into V′ in the formula (1) gives that when there is no change in Vᵢₙ or a change amplitude of Vᵢₙ is small, the voltage gain G will also change due to the change in V′. When circuit parameters are determined, A, n and fᵣ will be fixed. According to the voltage gain expression in the formula (1), the switching frequency f_{sw} of the synchronous rectifier switch S will change as the gain changes. When the conduction time of the body diode D1 changes periodically between Tₛ₁˜Tₛ₂, the gain also changes periodically, resulting in the change of f_{sw}, achieving the effect that the resonant circuit generates the frequency jitter, and achieving the purpose of reducing the switching noise.

It should be noted that the resonant circuit is electrically connected to the pre-stage circuit, the output of the pre-stage circuit is connected to the input of the resonant circuit, and when the input voltage of the pre-stage circuit is in the DC form, or the input voltage of the pre-stage circuit is in the AC form with the load being a light load, the conduction time of the body diode is adjusted in the different working periods to cause the switching frequency of the resonant circuit to change. The load being the light load means that a ratio of the current load to the full load is lower than a preset threshold, for example, 10%.

It should be noted that the working period refers to the switching period, that is, the switching period of the synchronous rectifier switch S.

In some embodiments, the conduction time of the body diode D₁ is adjusted in the different working periods to cause the switching frequency of the resonant circuit to change periodically. However, a period corresponding to the periodic change in the switching frequency of the resonant circuit is not the working period and is greater than the working period. The period corresponding to the periodic change in the switching frequency of the resonant circuit may have a time length of a plurality of working periods. That is, within several consecutive working periods, the switching frequency of the resonant circuit corresponding to each working period is different and changes continuously, which may be continuously increased or decreased, so as to achieve the frequency jitter effect.

Correspondingly, a conduction control signal of the body diode D₁ is a periodically changing signal, a period of which is greater than the working period, and may have the time length of the plurality of working periods. In a specific implementation, the conduction control signal of the body diode D₁ is a triangular wave, an exponential wave or a sine wave. It can be understood by those skilled in the art that the waveform of the conduction control signal of the body diode D₁ is only an example without limiting the protection scope of embodiments of the present disclosure, and any waveform of the conduction control signal of the body diode D₁ that can cause the switching frequency of the resonant circuit to change periodically can be adopted.

It can be seen from the above step that in the method for controlling the resonant circuit provided in embodiments of the present disclosure, the conduction time of the body diode is adjusted to cause the switching frequency of the resonant circuit to change, achieving the frequency jitter, so as to reduce the noise energy and reduce the switching noise in the resonant circuit, thereby meeting the EMI test requirements.

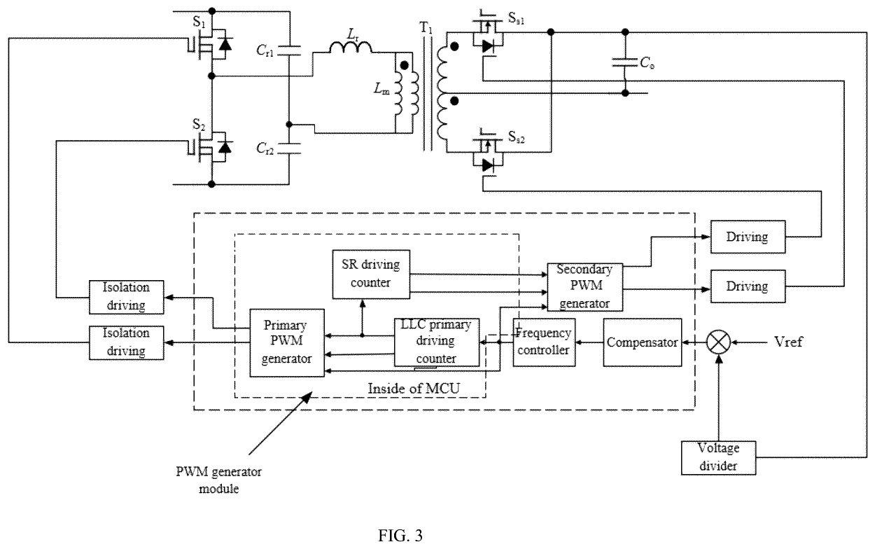

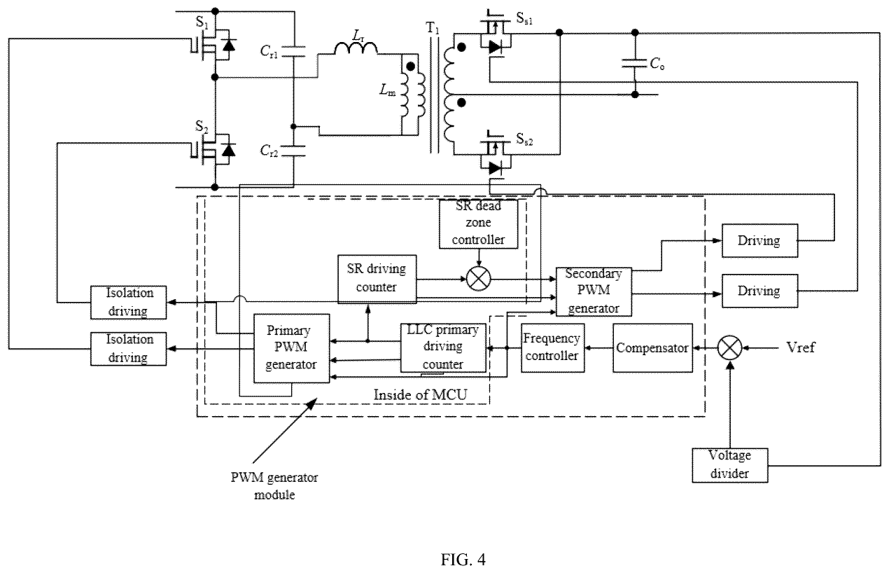

In order to better illustrate the method for controlling the resonant circuit provided in embodiments of the present disclosure and the achieved technical effect, a specific example is now given for further explanation. This specific example takes a specific LLC resonant converter as an example. Taking the control for the synchronous rectifier switch Sₛ₂ of the secondary switching circuit as an example, a block diagram of a control logic for the synchronous rectifier switch Sₛ₂ in the related arts as shown in FIG. 3 is provided, and a block diagram of a control logic for the synchronous rectifier switch Sₛ₂ by applying the control method provided in embodiments of the present disclosure as shown in FIG. 4 is provided.

As can be seen from FIG. 3, in addition to a sampling signal circuit and a main circuit, the LLC resonant converter mainly includes a compensator, a frequency controller, an LLC primary driving counter, a primary Pulse Width Modulation (PWM) generator, a secondary PWM generator, a primary isolation driving unit, a secondary driving unit and a Synchronous Rectification (SR) driving counter. FIG. 4 differs from FIG. 3 by the addition of a SR dead time controller to generate the conduction control signal of the body diode which is superimposed on the initial secondary PWM signal.

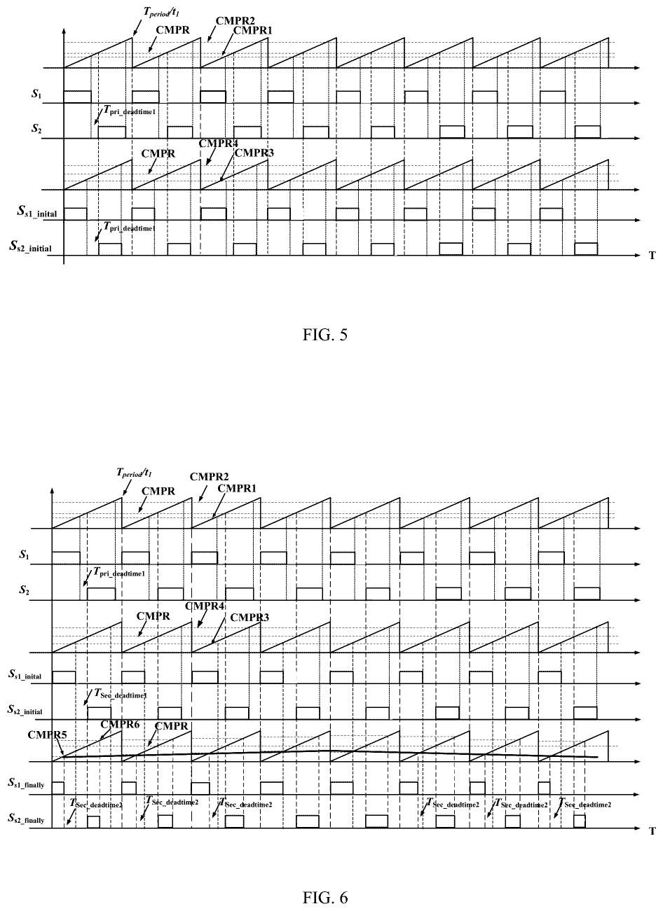

FIG. 5 shows a primary-secondary driving logic diagram corresponding to FIG. 3, and FIG. 6 shows a primary-secondary driving logic diagram corresponding to FIG. 4. It should be noted that abscissas of FIGS. 5 and 6 are time.

A formation process of a sawtooth wave is as follows: there is a crystal oscillator in an internal circuit or outside of a Micro Control Unit (MCU), which is used to set a time t₁ taken for each count inside the MCU; and the frequency controller outputs an LLC total counting period T_{period}, so in each counting period inside the PWM generator module, the total number of counts that need to be counted is I_{perid}/t₁, and the count starts from 0 to T_{perid}/t₁, and then starts from 0 again, and the sawtooth wave is formed.

A logic for generating the primary driving signal in FIGS. 5 and 6 is described as follows: in the LLC primary driving counter, a CMPR value and T_{pri_deadtime1} (representing a dead time between LLC primary switches S₁ and S₂) are generated. The CMPR value is equal to half of T_{period}/t₁, and T_{period}/t₁, the CMPR value and T_{pri_deadtime1} are given to the primary PWM generator. In the primary PWM generator, the CMPR value, T_{period}/t₁ and T_{pri_deadtime1} are used to generate a total of three values through mathematical operations, that is, a counter comparison value CMPR1 (CMPR-T_{pri_deadtime1}), a counter comparison value CMPR, a counter comparison value CMPR2 (T_{period}/t₁-T_{pri_deadtime1}). By comparing CMPR1, CMPR and CMPR2 with the sawtooth wave, the driving signal for the primary switch is generated. When the sawtooth wave is smaller than CMPR1, a signal S₁ in FIG. 5 or 6 is generated; and when the sawtooth wave is greater than the CMPR value and smaller than CMPR2, a signal S₂ in FIG. 5 or 6 is generated.

A logic for generating the secondary driving signal in FIG. 5 is described as follows: the CMPR value of the LLC primary counter is transferred to the SR driving counter, and the SR driving counter generates the CMPR value and T_{sec_deadtime1} (representing a dead time between LLC secondary synchronous rectifiers Sₛ₁ and Sₛ₂), and T_{period}/t₁, the CMPR value and T_{sec_deadtime1} are transferred to the secondary PWM generator. In the secondary PWM generator, T_{period}/t₁, the CMPR value and T_{sec_deadtime1} are used to generate a total of three values through mathematical operations, that is, a counter comparison value CMPR3 (CMPR-T_{sec_deadtime1}), a counter comparison value CMPR, a counter comparison value CMPR4 (T_{period}/t₁-T_{sec_deadtime1}). By comparing CMPR3, CMPR and CMPR4 with the sawtooth wave, the driving signal for the secondary switch is generated. When the sawtooth wave is smaller than CMPR3, the secondary switch Sₛ₁ is turned on, and a signal S_{s1_initial} in FIG. 5 is generated; and when the sawtooth wave is greater than the CMPR value and smaller than CMPR4, a signal S_{s2_initial} in FIG. 5 is generated.

FIG. 6 differs from FIG. 5 by the addition of the SR dead time controller to superpose a signal T_{sec_deadtime2} generated by the SR dead time controller on the initial fixed value T_{sec_deadtime1} in the generation logic of the SR driving counter, and T_{sec_deadtime2} changes according to the triangular wave (the waveform is not limited, which may be the triangular wave, the sine wave, the exponential wave or other waveforms, and the triangular wave is taken as an example here). T_{period}/t₁, the CMPR value and a superposition value T_{sec_deadtime} (the superimposition of T_{sec_deadtime1} and T_{sec_deadtime2}) are outputted to the secondary PWM generator. In the secondary PWM generator, T_{period}/t₁, the CMPR value and T_{sec_deadtime} are used to generate three new values through mathematical operations, that is, a counter comparison value CMPR5 (CMPR-T_{sec_deadtime}), a counter comparison value CMPR, a counter comparison value CMPR6 (T_{period}/t₁-T_{sec_deadtime}). By comparing CMPR5, CMPR, CMPR6 with the sawtooth wave, the driving signal for the secondary switch is generated. When the sawtooth wave is smaller than CMPR5, the secondary switch Sₛ₁ is turned on, and a signal Sₛ₁_finally in FIG. 6 is generated; and when the sawtooth wave is greater than the CMPR value and smaller than CMPR6, a signal S_{s2_finally} in FIG. 6 is generated.

It can be seen from FIG. 6 that T_{sec_deadtime2} is not a fixed value, but a waveform that changes according to the triangular wave, so as to achieve the purpose of changing the conduction time of the body diode according to the triangular wave form.

It can be seen from the above process that compared with the related arts, the SR dead time controller capable of outputting the conduction control signal of the body diode in the waveform of the triangular wave, the sine wave or the exponential wave is added within the PWM generator module in this specific example, so that the conduction time of the secondary switch after the superimposition is gradually increased or decreased in several consecutive different working periods, and then the switching frequency of the LLC resonant converter changes periodically (which is not the working period of the switch), which achieves the effect of frequency jitter and reduces the switching noise to meet the EMI test requirements.

Based on the same inventive concept, embodiments of the present disclosure further provide a resonant circuit. Since a principle of solving the problem in the resonant circuit embodiments is similar to that in the above method embodiments, the implementation of the resonant circuit embodiments may refer to the implementation of the above method embodiments, and the repeated parts will not be repeated.

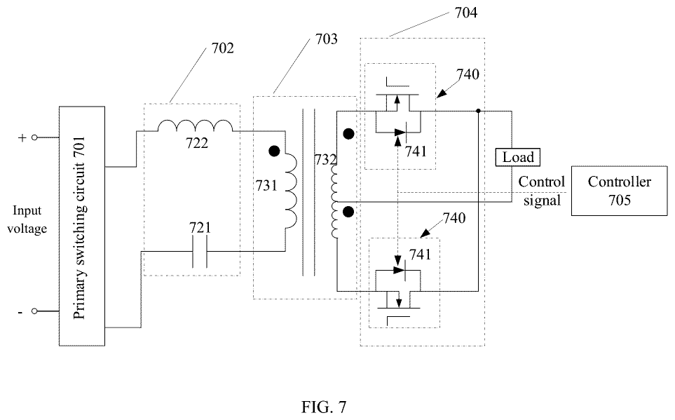

FIG. 7 shows a simplified schematic structural diagram of a resonant circuit according to an embodiment of the present disclosure. As shown in FIG. 7, the resonant circuit includes:
a primary switching circuit 701, configured to receive an input voltage;
a resonant branch 702, including a capacitor 721 and an inductor 722 connected in series;
a transformer 703, including a primary winding 731 and a secondary winding 732, and the resonant branch 702 is connected between the primary switching circuit 701 and the primary winding 731;
a secondary switching circuit 704, connected to the secondary winding 732 and configured to provide an output voltage to a load, and the secondary switching circuit 704 includes a synchronous rectifier switch 740, and the synchronous rectifier switch 740 includes a body diode 741; and
a controller 705, configured to adjust, in different working periods, a conduction time of the body diode 741 to cause a switching frequency of the resonant circuit to change.

It should be noted that the controller 705 is configured to:
adjust, in the different working periods, the conduction time of the body diode 741 to cause the switching frequency of the resonant circuit to periodically change.

A conduction control signal of the body diode 741 is a periodically changing signal, and a period of the periodically changing signal is greater than the working period. The conduction control signal of the body diode 741 is a triangular wave, an exponential wave or a sine wave.

The resonant circuit is typically used as the post-stage circuit of the two-stage circuit. The resonant circuit is electrically connected to the pre-stage circuit, and the output of the pre-stage circuit is connected to the input of the resonant circuit.

Further, the controller 705 is configured to:
when an input voltage of the pre-stage circuit is in a direct current form, or when the input voltage of the pre-stage circuit is in an alternating current form and the load is a light load, adjust, in the different working periods, the conduction time of the body diode 741 to cause the switching frequency of the resonant circuit to change.

Those skilled in the art can understand that various aspects of the present disclosure may be implemented as a system, a method, or a program product. Therefore, various aspects of the present disclosure can be embodied in the following forms: a complete hardware implementation, a complete software implementation (including firmware, microcode, etc.), or a combination of hardware and software implementations, which can be collectively referred to as “circuit”, “module’, or “system”. It should be noted that although several modules or units of devices for executing actions in the above detailed description are mentioned, such division of modules or units is not mandatory. In fact, features and functions of two or more of the modules or units described above may be embodied in one module or unit in accordance with embodiments of the present disclosure. Alternatively, the features and functions of one module or unit described above may be further divided into multiple modules or units.

In addition, although various steps of the method of the present disclosure are described in a particular order in the figures, this is not required or implied that the steps must be performed in the specific order, or all the steps shown must be performed to achieve the desired result. Additionally or alternatively, certain steps may be omitted, multiple steps may be combined into one step, and/or one step may be decomposed into multiple steps and so on.

Through the description of the above embodiments, those skilled in the art will readily understand that the example embodiments described herein may be implemented by software or by a combination of software with necessary hardware. Therefore, the technical solutions according to embodiments of the present disclosure may be embodied in the form of a software product, which may be stored in a non-volatile storage medium (which may be a CD-ROM, a USB flash drive, a mobile hard disk, etc.) or on a network. A number of instructions are included to cause a computing device (which may be a personal computer, server, mobile terminal, or network device, etc.) to perform the methods in accordance with embodiments of the present disclosure.

Other embodiments of the present disclosure will be apparent to those skilled in the art after those skilled in the art consider the specification and practice the technical solutions disclosed herein. The present application is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative, and the real scope and spirit of the present disclosure is defined by the appended claims.

What is claimed is:

1. A method for controlling a resonant circuit, wherein the resonant circuit comprises:
a primary switching circuit, configured to receive an input voltage;
a resonant branch, comprising a capacitor and an inductor connected in series;
a transformer, comprising a primary winding and a secondary winding, wherein the resonant branch is connected between the primary switching circuit and the primary winding; and
a secondary switching circuit, connected to the secondary winding and configured to provide an output voltage to a load, wherein the secondary switching circuit comprises a synchronous rectifier switch, and the synchronous rectifier switch comprises a body diode;
the method comprises:
adjusting, in different working periods, a conduction time of the body diode to cause a switching frequency of the resonant circuit to change.

2. The method according to claim 1, wherein the adjusting, in the different working periods, the conduction time of the body diode to cause the switching frequency of the resonant circuit to change comprises:
adjusting, in the different working periods, the conduction time of the body diode to cause the switching frequency of the resonant circuit to periodically change.

3. The method according to claim 2, wherein a conduction control signal of the body diode is a periodically changing signal, and a period of the periodically changing signal is greater than a working period.

4. The method according to claim 3, wherein the conduction control signal of the body diode is a triangular wave, an exponential wave or a sine wave.

5. The method according to claim 1, wherein the resonant circuit is electrically connected to a pre-stage circuit, and an output of the pre-stage circuit is connected to an input of the resonant circuit;
the adjusting, in the different working periods, the conduction time of the body diode to cause the switching frequency of the resonant circuit to change comprises:
in a case where an input voltage of the pre-stage circuit is in a direct current form, or in a case where the input voltage of the pre-stage circuit is in an alternating current form and the load is a light load, adjusting, in the different working periods, the conduction time of the body diode to cause the switching frequency of the resonant circuit to change.

6. A resonant circuit, comprising:
a primary switching circuit, configured to receive an input voltage;
a resonant branch, comprising a capacitor and an inductor connected in series;
a transformer, comprising a primary winding and a secondary winding, wherein the resonant branch is connected between the primary switching circuit and the primary winding;
a secondary switching circuit, connected to the secondary winding and configured to provide an output voltage to a load, wherein the secondary switching circuit comprises a synchronous rectifier switch, and the synchronous rectifier switch comprises a body diode; and
a controller, configured to adjust, in different working periods, a conduction time of the body diode to cause a switching frequency of the resonant circuit to change.

7. The resonant circuit according to claim 6, wherein the controller is configured to:
adjust, in the different working periods, the conduction time of the body diode to cause the switching frequency of the resonant circuit to periodically change.

8. The resonant circuit according to claim 7, wherein a conduction control signal of the body diode is a periodically changing signal, and a period of the periodically changing signal is greater than a working period.

9. The resonant circuit according to claim 8, wherein the conduction control signal of the body diode is a triangular wave, an exponential wave or a sine wave.

10. The resonant circuit according to claim 6, wherein the resonant circuit is electrically connected to a pre-stage circuit, and an output of the pre-stage circuit is connected to an input of the resonant circuit, and
the controller is configured to:
in a case where an input voltage of the pre-stage circuit is in a direct current form, or in a case where the input voltage of the pre-stage circuit is in an alternating current form and the load is a light load, adjust, in the different working periods, the conduction time of the body diode to cause the switching frequency of the resonant circuit to change.
